(19) United States
(12) Patent Application Publication
(10) Pub. No.: US 2017/0061700 A1
(43) Pub. Date: Mar. 2, 2017

(54) INTERCOMMUNICATION BETWEEN A HEAD MOUNTED DISPLAY AND A REAL WORLD OBJECT

(71) Applicants: Julian Michael Urbach, Los Angeles, CA (US); Nicolas Lazareff, Los Angeles, CA (US)

(72) Inventors: Julian Michael Urbach, Los Angeles, CA (US); Nicolas Lazareff, Los Angeles, CA (US)

(21) Appl. No.: 14/621,621

(22) Filed: Feb. 13, 2015

(51) Int. Cl. G06T 19/20; G06F 3/01; G06Q 20/12; G06F 3/0481; G06F 3/0484; G06T 15/00; G06F 3/0488

(52) U.S. Cl. CPC G06T 19/20; G06T 15/005; G06F 3/013; G06F 3/0488; G06F 3/04815; G06F 3/04845; G06Q 20/123; G06T 2215/16

(57) ABSTRACT

User interaction with virtual objects generated in virtual space on a first display device is enabled. Using sensor and camera data of the first display device, a real-world object with a marker on its surface is identified. Virtual objects are generated and displayed in the virtual 3D space relative to the marker on the real-world object. Manipulation of the real-world object in real 3D space results in changes to attributes of the virtual objects in the virtual 3D space. The marker comprises information regarding particular the renders to be generated. Different virtual objects can be generated and displayed based on information comprised in the markers. When the real world object has sensors, sensor data from the real-world object is transmitted to the first display device to enhance the display of the virtual object, or the virtual scene, based on sensor input. Local or remote storage can further define, enhance, or modify characteristics of the real world object.

### BACKGROUND

Rapid developments that occurred in the Internet, mobile data networks and hardware led to the development of many types of devices. Such devices include larger devices like laptops to smaller devices that comprise wearable devices that are borne on users' body parts. Examples of such wearable devices comprise eye-glasses, head-mounted displays, smartwatches or devices to monitor a wearer's biometric information. Mobile data comprising one or more of text, audio and video data can be streamed to the device. However, their usage can be constrained due to their limited screen size and processing capabilities.

### SUMMARY

This disclosure relates to systems and methods for enabling user interaction with virtual objects wherein the virtual objects are rendered in a virtual 3D space via manipulation of real-world objects and enhanced or modified by local or remote data sources. A method for enabling user interactions with virtual objects is disclosed in some embodiments. The method comprises detecting, by a processor in communication with a first display device, presence of a real-world object comprising a marker on a surface thereof. The processor identifies position and orientation of the real-world object in real 3D space relative to a user's eyes and renders a virtual object positioned and oriented in a virtual 3D space relative to the marker. The display of the virtual object is controlled via a manipulation of the real-world object in real (3D) space. The method further comprises transmitting render data by the processor to visually present the virtual object on the first display device. In some embodiments, the visual presentation of the virtual object may not comprise the real-world object so that only the virtual object is seen by the user in the virtual space. In some embodiments, the visual presentation of the virtual object can comprise an image of the real-world object so that the view of the real-world object is enhanced or modified by the virtual object.

In some embodiments, the method of configuring the virtual object for being manipulable via manipulation of the real-world object further comprises, detecting, by the processor, a change in one of the position and orientation of the real-world object, altering one or more attributes of the virtual object in the virtual space based on the detected change in the real-world object and transmitting, by the processor to the first display device, render data to visually display the virtual object with the altered attributes.

In some embodiments, the real world object is a second display device comprising a touchscreen. The second display device lies in a field of view of a camera of the first display device and is communicably coupled to the first display device. Further, the marker is displayed on the touchscreen of the second display device. The method further comprises receiving, by the processor, data regarding the user's touch input from the second display device and manipulating the virtual object in the virtual space in response to the data regarding the user's touch input. In some embodiments, the data regarding the user's touch input comprising position information of the user's body part on the touchscreen relative to the marker and the manipulation of the virtual object further comprises changing, by the processor, a position of the virtual object in the virtual space to track the position information or a size of the virtual object in response to the user's touch input. In some embodiments, the user's touch input corresponds to one of a single or multi-tap, tap-and-hold, rotate, swipe, or pinch-zoom gesture. In some embodiments, the method further comprises receiving, by the processor, data regarding input from at least one of a plurality of sensors comprised in one or more of the first display device and the second display device and manipulating, by the processor, one of the virtual object and a virtual scene in response to such sensor input data. In some embodiments, the plurality of sensors can comprise a camera, gyroscopes(s), accelerometer(s) and magnetometers. Thus, the sensor input data from the first and/or the second display devices enables mutual tracking. So even if one or more of the first and the second display device move out of the other's field of view, precise relative position tracking is enabled by the mutual exchange of such motion/position sensor data between the first and second display devices.

In some embodiments, the real world object is a 3D printed model of another object and the virtual object comprises a virtual outer surface of the other object. The virtual outer surface encodes real-world surface reflectance properties of the other object. The size of the virtual object can be substantially similar to the size of the 3D printed model. The method further comprises rendering, by the processor, the virtual outer surface in response to further input indicating a purchase of the rendering.

A computing device comprising a processor and a storage medium for tangibly storing thereon program logic for execution by the processor is disclosed in some embodiments. The programming logic enables the processor to execute various tasks associated with enabling user interactions with virtual objects. Presence detecting logic, executed by the processor, for detecting in communication with a first display device, presence of a real-world object comprising a marker on a surface thereof Identifying logic, is executed by the processor, for identifying position and orientation of the real-world object in real 3D space relative to a user's eyes. The processor executes rendering logic for rendering a virtual object positioned and oriented in a virtual 3D space relative to the marker, manipulation logic for manipulating the virtual object responsive to a manipulation of the real-world object in the real 3D space and transmitting logic, for transmitting render data by the processor to visually display, the virtual object on a display of the first display device.

In some embodiments, the manipulation logic further comprises change detecting logic, executed by the processor, for detecting a change in one of the position and orientation of the real-world object, altering logic, executed by the processor, for altering one or more of the position and orientation of the virtual object in the virtual space based on the detected change in the real-world object and change transmitting logic, executed by the processor, for transmitting to the first display device, the altered position and orientation.

In some embodiments, the real world object is a second display device comprising a touchscreen and a variety of sensors. The second display device a) lies in a field of view of a camera of the first display device, and is communicably coupled to the first display device, although presence in the field of view is not required as other sensors can also provide useful data for accurate tracking of the two devices each relative to the other. The marker is displayed on the touchscreen of the second display device and the manipulation logic further comprises receiving logic, executed by the processor, for receiving data regarding the user's touch input from the second display device and logic, executed by the processor for manipulating the virtual object in the virtual space in response to the data regarding the user's touch input. The data regarding the user's touch input can comprise position information of the user's body part on the touchscreen relative to the marker. The manipulation logic further comprises position changing logic, executed by the processor, for changing a position of the virtual object in the virtual space to track the position information and size changing logic, executed by the processor, for changing a size of the virtual object in response to the user's touch input.

In some embodiments, the processor is comprised in the first display device and the apparatus further comprises display logic, executed by the processor, for displaying the virtual object on the display of the first display device.

A non-transitory processor-readable storage medium comprising processor-executable instructions for detecting, by the processor in communication with a first display device, presence of a real-world object comprising a marker on a surface thereof In some embodiments, the non-transitory processor-readable medium further comprises instructions for identifying position and orientation of the real-world object in real 3D space relative to a user's eyes, rendering a virtual object positioned and oriented in a virtual 3D space relative to the marker, the virtual object being manipulable via a manipulation of the real-world object in the real 3D space; and transmitting render data by the processor to visually display, the virtual object on a display of the first display device. In some embodiments, the instructions for manipulation of the virtual object via manipulation of the real-world object further comprises instructions for detecting a change in one of the position and orientation of the real-world object, altering one or more of the position and orientation of the virtual object in the virtual space based on the detected change in the real-world object and displaying to the user, the virtual object at one or more of the altered position and orientation based on the detected change.

In some embodiments, the real world object is a second display device comprising a touchscreen which lies in a field of view of a camera of the first display device and is communicably coupled to the first display device. The marker is displayed on the touchscreen of the second display device. The non-transitory medium further comprises instructions for receiving, data regarding the user's touch input from the second display device and manipulating the virtual object in the virtual space in response to the data regarding the user's touch input.

In some embodiments, the real world object is a 3D printed model of another object and the virtual object comprises a virtual outer surface of the other object. The virtual outer surface encodes real-world surface reflectance properties of the other object and the size of the virtual object is substantially similar to a size of the 3D printed model. The non-transitory medium further comprises instructions for rendering, by the processor, the virtual outer surface in response to further input indicating a purchase of the rendering. In some embodiments, the render data further comprises data to include an image of the real-world object along with the virtual object in the visual display. In some embodiments, the virtual object can modify or enhance the image of the real-world object in the display generated from the transmitted render data.

These and other embodiments/will be apparent to those of ordinary skill in the art with reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is an illustration that shows a user interacting with a virtual object generated in a virtual world via manipulation of a real-world object in the real-world in accordance with some embodiments;

FIG. 2 is an illustration that shows generation of a virtual object with respect to a marker on a touch-sensitive surface in accordance with some embodiments;

FIG. 3 is another illustration that shows user interaction with a virtual object in accordance with some embodiments;

FIG. 4 is an illustration that shows providing depth information along with lighting data of an object to a user in accordance with some embodiments described herein;

FIG. 5 is a schematic diagram of a system for establishing a control mechanism for volumetric displays in accordance with embodiments described herein;

FIG. 6 is a schematic diagram of a preprocessing module in accordance with some embodiments;

FIG. 7 is a flowchart that details an exemplary method of enabling user interaction with virtual objects in accordance with one embodiment;

FIG. 8 is a flowchart that details an exemplary method analyzing data regarding changes to the real-world object attributes and identifying corresponding changes to the virtual object 204 in accordance with some embodiments;

FIG. 9 is a flowchart that details an exemplary method of providing lighting data of an object along with its depth information in accordance with some embodiments described herein;

FIG. 10 is a block diagram depicting certain example modules within the wearable computing device in accordance with some embodiments;

FIG. 11 is a schematic diagram that shows a system for purchase and downloading of renders in accordance with some embodiments;

FIG. 12 illustrates internal architecture of a computing device in accordance with embodiments described herein; and

FIG. 13 is a schematic diagram illustrating a client device implementation of a computing device in accordance with embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Embodiments are described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions or logic can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks, thereby changing the character and or functionality of the executing device.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server. Servers may vary widely in configuration or capabilities, but generally a server may include one or more central processing units and memory. A server may also include one or more additional mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including radio, infrared, optical or other wired or wireless communication methodology satellite links, or other communication links, wired or wireless such as may be known or to become known to those skilled in the art. Furthermore, a computing device or other related electronic devices may be remotely coupled to a network, such as via a telephone line or link, for example.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various devices are currently in use for accessing content that may be stored locally on a device or streamed to the device via local networks such as a Bluetooth™ network or larger networks such as the Internet. With the advent of wearable devices such as smartwatches, eye-glasses and head-mounted displays, a user does not need to carry bulkier devices such as laptops to access data. Devices such as eye-glasses and head-mounted displays worn on a user's face operate in different modes which can comprise an augmented reality mode or virtual reality mode. In an augmented reality mode, displays of visible images are overlaid as the user observes the real world through the lenses or viewing screen of the device as generated by an associated processor. In the virtual reality mode, a user's view of the real world is replaced by the display generated by a processor associated with the lenses or viewing screen of the device.

Regardless of the mode of operation, interacting with the virtual objects in the display can be rather inconvenient for users. While commands for user interaction may involve verbal or gesture commands, finer control of the virtual objects, for example, via tactile input is not enabled on currently available wearable devices. In virtual environment requiring finer control of virtual objects such as, when moving virtual objects along precise trajectories, for example, files to specific folders or virtual objects in gaming environments, enabling tactile input in addition to feedback via visual display can improve the user experience.

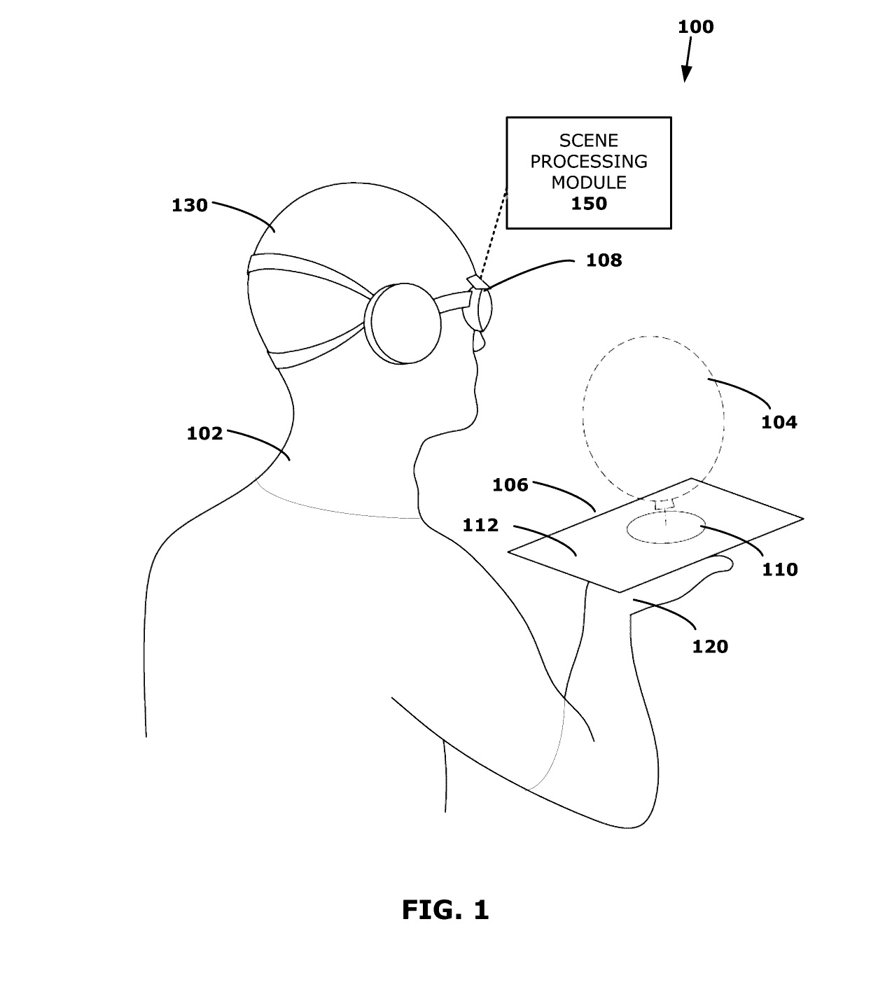

Embodiments are disclosed herein to enhance user experience in virtual environments generated, for example, by wearable display devices by implementing a two-way communication between physical objects and the wearable devices. FIG. 1 is an illustration 100 that shows a user 102 interacting with a virtual object 104 generated in a virtual world via interaction with a real-world object 106 in the real-world. The virtual object 104 is generated by a scene processing module 150 in communication with or a part of or a component of a wearable computing device 108. In some embodiments, the scene processing module 150 can be executed by another processor that can send data to wearable device 108 wherein the other processor can be integral, partially integrated or separate from the wearable device 108. The virtual object 104 is generated relative to a marker 110 visible or detectable in relation to a surface 112 of the real-world object 106. The virtual object 104 can be further anchored relative to the marker 110 so that any changes to the marker 110 in the real-world can cause a corresponding or desired change to the attributes of the virtual object 104 in the virtual world.

In some embodiments, the virtual object 104 can comprise a 2D (two-dimensional) planar image, 3D (three-dimensional) volumetric hologram, or light field data. The virtual object 104 is projected by the wearable device 108 relative to the real-world object 106 and viewable by the user 102 on the display screen of the wearable device 108. In some embodiments, the virtual object 104 is anchored relative to the marker 110 so that one or more of a shift, tilt or rotation of the marker 110 (or the surface 112 that bears the marker thereon) can cause a corresponding shift in position or a tilt and/or rotation of the virtual object 104. It can be appreciated that changes to the positional attributes of the marker 110 (such as its position or orientation in space) occur not only due to the movement of the real-world object 106 by the user 120 but also due to the displacement of the user's 102 head 130 relative to the real-world object 106. Wearable devices 108 as well as object 106 generally comprise positioning/movement detection components such as gyroscopes, or software or hardware elements that generate data that permits a determination of the position of the wearable device 108 relative to device 106. The virtual object 104 can be changed based on the movement of the user's head 130 relative to the real-world object 106. In some embodiments, changes in the virtual object 104 corresponding to the changes in the real-world object 106 can extend beyond visible attributes of the virtual object 104. For example, if the virtual object 104 is a character in a game, the nature of the virtual object 104 can be changed based on the manipulation of the real-world object subject to the programming logic of the game.

The virtual object 104 in the virtual world reacts to the position/orientation of the marker 110 in the real-world and the relative determination of orientation of devices 106 and 108. The user 102 is therefore able to interact with or manipulate the virtual object 104 via a manipulation of the real-world object 106. It may be appreciated that only the position and orientation are discussed with respect to the example depicted in FIG. 1 as the surface 112 bearing the marker 110 is assumed to be touch-insensitive. Embodiments are discussed herein wherein real-world objects having touch-sensitive surfaces bearing markers thereon are used, although surface 112 may be a static surface such as a sheet of paper with a mark made by the user 102, game board, or other physical object capable of bearing a marker. While the surface 112 is shown as planar, this is only by way of illustration and not limitation. Surfaces comprising curvatures, ridges or other irregular shapes can also be used in some embodiments. In some embodiments, the marker 110 can be any identifying indicia recognizable by the scene processing module 150. Such indicia can comprise without limitation QR (Quick Response) codes, bar codes, or other images, text or even user-generated indicia as described above. In some embodiments, the entire surface 112 can be recognized as a marker, for example, via a texture shape or size of the surface 112 and hence a separate marker 110 may not be needed.

In cases where the real-world object 106 is a display device the marker can be an image or text or object displayed on the real-world object 106. This enables controlling attributes of the virtual object 104 other than its position and orientation such as but not limited to its size, shape, color or other attribute via the touch-sensitive surface as will be described further herein. It may be appreciated that in applying the techniques described herein changes in an attribute of the virtual object 104 is in reaction to or responsive to the user's manipulation of the real-world object 106.

Wearable computing device 108 can include but is not limited to augmented reality glasses such as GOOGLE GLASS™, Microsoft HoloLens, and ODG (Osterhout Design Group) SmartGlasses and the like in some embodiments. Augmented reality (AR) glasses enable the user 102 to see his/her surroundings while augmenting the surroundings by displaying additional information retrieved from a local storage of the AR glasses or from online resources such as other servers. In some embodiments, the wearable device can comprise virtual reality headsets such as for example SAMSUNG GEAR VR™ or Oculus Rift. In some embodiments, a single headset that can act as augmented reality glasses or as virtual reality glasses can be used to generate the virtual object 104. The user 102 therefore may or may not be able to see the real-world object 106 along with the virtual object 104 based on the mode in which the wearable device 108 is operating. Embodiments described herein combine the immersive nature of the VR environment with the tactile feedback associated with the AR environment.

Virtual object 104 can be generated either directly by the wearable computing device 108 or it may be a rendering received from another remote device (not shown) communicatively coupled to the wearable device 108. In some embodiments the remote device can be a gaming device connected via short range networks such as the Bluetooth network or other near-field communication. In some embodiments, the remote device can be a server connected to the wearable device 108 via Wi-Fi or other wired or wireless connection.

When the user 102 initially activates the wearable computing device 102, a back-facing camera or other sensing device such as an IR detector (not shown) that points away from the user's 102 face comprised in the wearable computing device 108 is activated. Based on the positioning of the user's 102 head or other body part, the camera or sensor can be made to receive as input image data associated with the real-world object 106 present in or proximate the user's 102 hands. In some embodiments, the sensor receives data regarding the entire surface 112 including the position and orientation of the marker 110. The received image data can be used with known or generated light field data of the virtual object 104 in order to generate the virtual object 104 at a position/orientation relative to the marker 110. In embodiments wherein a rendering of the virtual object 104 is received by the wearable device 108, the scene processing module 150 positions and orients the rendering of the virtual object 104 relative to the marker 110.

When the user 102 makes a change to an attribute (position or otherwise) of the real-world object 106 in the real-world, the change is detected by the camera on the wearable device 108 and provided to the scene processing module 150. The scene processing module 150 makes the corresponding changes to one of the virtual object 104 or a virtual scene surrounding the virtual object 104 in the virtual world. For example, if the user 102 displaces or tilts the real-world object such information is obtained by the camera of the wearable device 108 which provides the obtained information to the scene processing module 150. Based on the delta between the current position/orientation of the real-world object 106 and the new position/orientation of the real-world object 106, the scene processing module 150 determines the corresponding change to be applied to the virtual object 104 and/or the virtual scene in which the virtual object 104 is generated in the virtual 3D space. A determination regarding the changes to be applied to one or more of the virtual object 104 and virtual scene can be made based on the programming instructions associated with the virtual object 104 or the virtual scene. In other embodiments where the real-world object 106 has the capability to detect its own position/orientation, object 106 can communicate its own data that can be used alone or in combination with data from camera/sensor on the wearable device 108.

In some embodiments, the changes implemented to the virtual object 104 corresponding to the changes in the real-world object 106 can depend on the programming associated with the virtual environment. The scene processing module 150 can be programmed to implement different changes to the virtual object 104 in different virtual worlds corresponding to a given change applied to the real-world object. For example, a tilt in the real-world object 106 may cause a corresponding tilt in the virtual object 104 in a first virtual environment, whereas the same tilt of the real-world object 106 may cause different change in the virtual object 104 in a second virtual environment. A single virtual object 104 is shown herein for simplicity. However, a plurality of virtual objects positioned relative to each other and to the marker 110 can also be generated and manipulated in accordance with embodiments described herein.

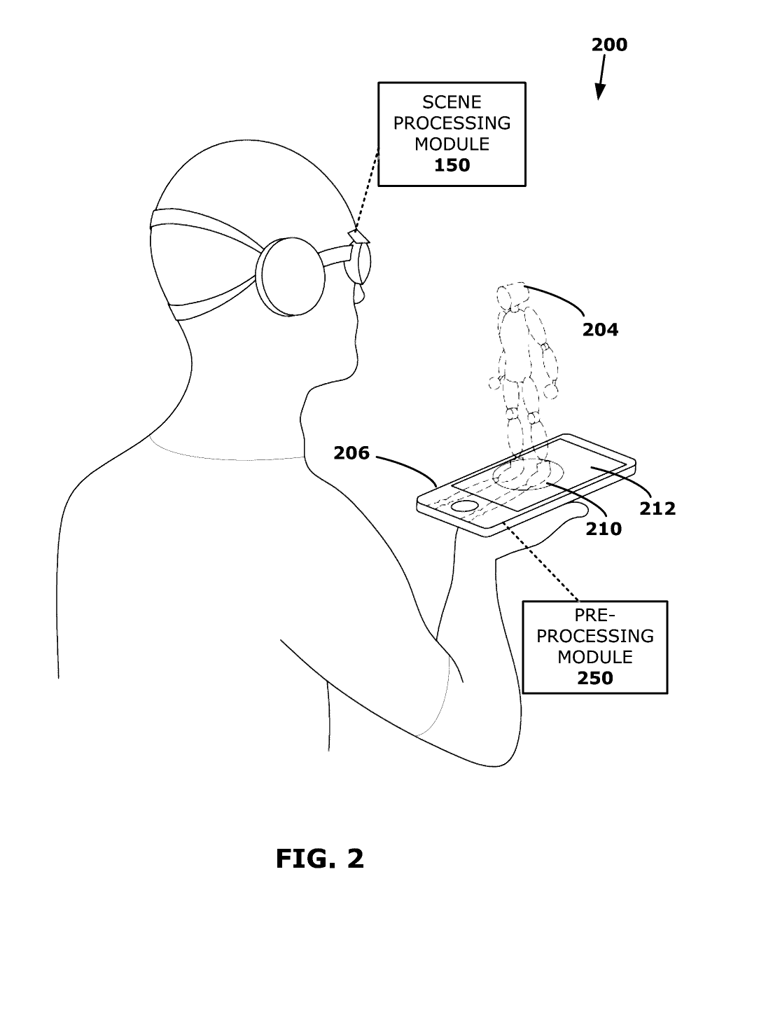

FIG. 2 is an illustration 200 that shows generation of a virtual object 204 with respect to a marker 210 on a touch-sensitive surface 212 in accordance with some embodiments. In this case a computing device with a touchscreen can be used in place of the touch-insensitive real-world object 106. The user 102 can employ a marker 210 generated on a touchscreen 212 of a computing device 206 by a program or software executing thereon. Examples of such computing devices which can be used as real-world objects can comprise without limitation smartphones, tablets, phablets, e-readers or other similar handheld devices. In this case, a two way communication channel can be established between the wearable device 108 and the handheld device 206 via a short range network such as Bluetooth™ and the like. Moreover, image data of the handheld computing device 206 is obtained by the outward facing camera or the sensor of the wearable device 108. Similarly, image data associated with the wearable device 208 can be received by a front-facing camera of the handheld device 206 also. Usage of a computing device 206 enables a more precise position-tracking of the marker 210 as each of the wearable device 108 and the computing device 206 is able to track the other device's position relative to itself and communicate such position data between devices as positions change.

A pre-processing module 250 executing on or in communication with the computing device 206 can be configured to transmit data from the positioning and/or motion sensing components of the computing device 206 to the wearable device 108 via a communication channel, such as, the short-range network. The pre-processing module 250 can also be configured to receive positioning data from external sources such as the wearable device 108. By the way of illustration and not limitation, the sensor data can be transmitted by one or more of the scene-processing module 150 and the pre-processing module 250 as packetized data via the short-range network wherein the packets are configured for example, in FourCC (four character code) format. Such mutual exchange of position data enables a more precise positioning or tracking of the computing device 206 relative to the wearable device 108. For example, if one or more of the computing device 206 and the wearable device 108 move out of the field of view of the other's camera, they can still continue to track each other's position via the mutual exchange of the position/motion sensor data as detailed herein. In some embodiments, the scene processing module 150 can employ sensor data fusion techniques such as but not limited to Kalman filters or multiple view geometry to fuse image data in order to determine the relative position of the computing device 206 and the wearable device 108.

In some embodiments, the pre-processing module 250 can be a software of an ‘app’ stored in a local storage of the computing device 206 and executable by a processor comprised within the computing device 206. The pre-processing module 250 can be configured with various sub-modules that enable execution of different tasks associated with the display of the renderings and user interactions of virtual objects in accordance with the various embodiments as detailed herein.

The pre-processing module 250 can be further configured to display the marker 210 on the surface 212 of the computing device 206. As mentioned supra, the marker 210 can be an image, a QR code, a bar code and the like. Hence, the marker 210 can be configured so that it encodes information associated with the particular virtual object 204 to be generated. In some embodiments, the pre-processing module 250 can be configured to display different markers each of which can each encode information corresponding to a particular virtual object. In some embodiments, the markers can be user-selectable. This enables the user 102 to choose the virtual object to be rendered. In some embodiments, one or more of the markers can be selected/displayed automatically based on the virtual environment and/or content being viewed by the user 102.

When the particular marker, such as marker 210 is displayed, the wearable device 108 can be configured to read the information encoded therein and render/display a corresponding virtual object 204. Although only one marker 210 is shown in FIG. 2 for simplicity, it may be appreciated that a plurality of markers each encoding data of one of a plurality of virtual objects can also be displayed simultaneously on the surface 212. If the plurality of markers displayed on the surface 212 are unique, different virtual objects are displayed simultaneously. Similarly multiple instances of a single virtual object can be rendered wherein each of the markers will comprise indicia identifying a unique instance of the virtual object so that a correspondence is maintained between a marker and its virtual object. Moreover, it may be appreciated that number of the markers that can be simultaneously displayed would be subject to constraints of the available surface area of the computing device 206.

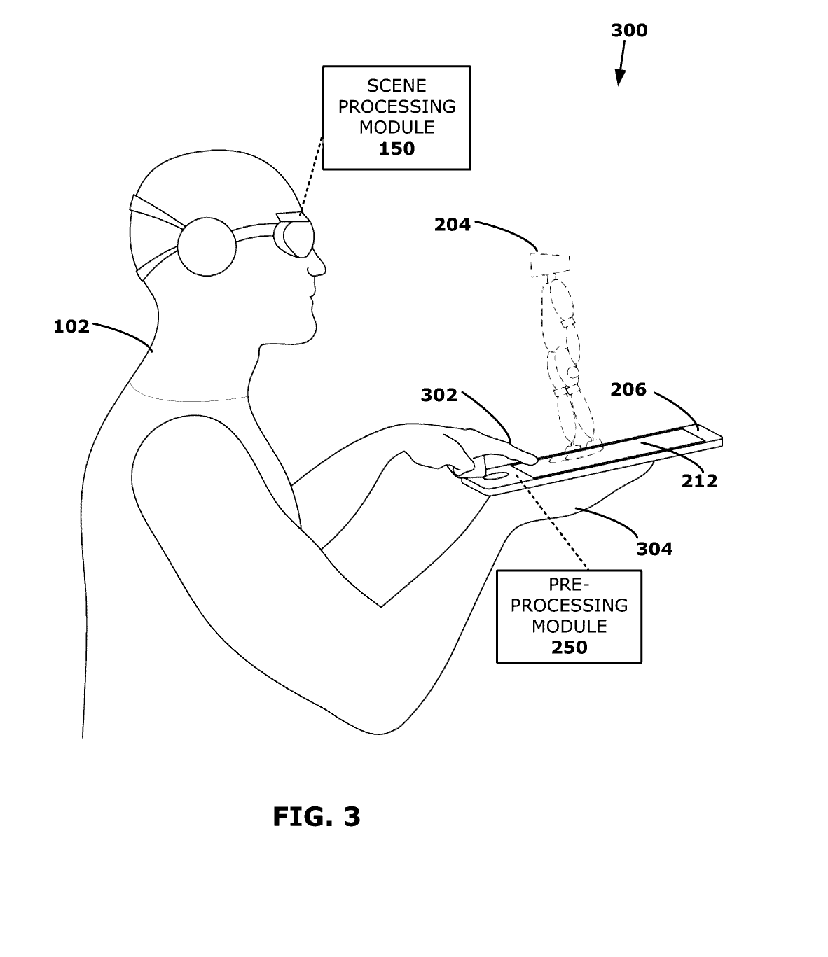

FIG. 3 is another illustration 300 that shows user interaction with a virtual object in accordance with some embodiments. An advantage of employing a computing device 206 as a real-world anchor for the virtual object 204 is that the user 102 is able to provide touch input via the touchscreen 212 of the computing device 206 in order to interact with the virtual object 204. The pre-processing module 250 executing on the computing device 206 receives the user's 102 touch input data from the sensors associated with the touchscreen 212. The received sensor data is analyzed by the pre-processing module 250 to identify the location and trajectory of the user's touch input relative to one or more of the marker 210 and the touchscreen 212. The processed touch input data can be transmitted to the wearable device 108 via a communication network for further analysis. The user's 102 touch input can comprise a plurality of vectors in some embodiments. The user 102 can provide multi-touch input by placing a plurality of fingers in contact with the touchscreen 212. Accordingly, each finger comprises a vector of the touch input with the resultant changes to the attributes of the virtual object 204 being implemented as a function of the user's touch vectors. In some embodiments, a first vector of the user's input can be associated with the touch of the user's finger 302 relative to the touchscreen 212. A touch, gesture, sweep, tap or multi-digit action can be used as examples of vector generating interactions with screen 212. A second vector of the user's input can comprise the motion of the computing device 206 by the user's hand 304. Based on the programming logic of the virtual environment in which the virtual object 204 is generated, one or more of these vectors can be employed for manipulating the virtual object 204. Operations that are executable on the virtual object 204 via the multi-touch control mechanism comprise without limitation, scaling, rotating, shearing, lasing, extruding or selecting parts of the virtual object 204 thereof.

If the virtual object 204 is rendered by the wearable device 108, the corresponding changes to the virtual object 204 can be executed by the scene processing module 150 of the wearable device 108. If the rendering occurs at a remote device, the processed touch input data is transmitted to the remote device in order to cause appropriate changes to the attributes of the virtual object 204. In some embodiments, the processed touch input data can be transmitted to the remote device by the wearable device 108 upon receipt of such data from the computing device 206. In some embodiments, the processed touch input data can be transmitted directly from the computing device 206 to the remote device for causing changes to the virtual object 204 accordingly.

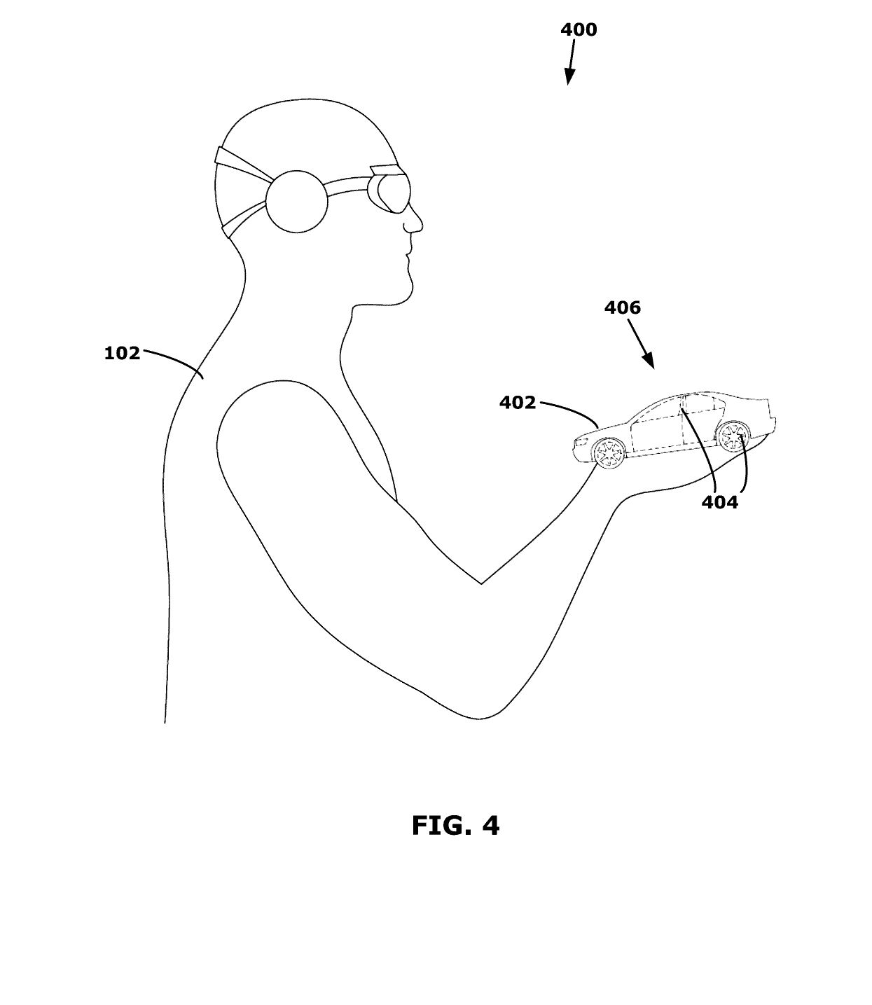

The embodiments described herein provide a touch-based control mechanism for volumetric displays generated by wearable devices. The attribute changes that can be effectuated on the virtual object 204 via the touch input can comprise without limitation, changes to geometric attributes such as, position, orientation, magnitude and direction of motion, acceleration, size, shape or changes to optical attributes such as lighting, color, or other rendering properties. For example, if the user 102 is in a virtual space such as a virtual comic book shop, an image of the computing device 206 is projected even as the user 102 holds the computing device 206. This gives the user 102 a feeling that he is holding and manipulating a real-world book as the user 102 is holding a real-world object 206. However, the content the user 102 sees on the projected image of the computing device 206 is virtual content not seen by users outside of the virtual comic book shop. FIG. 4 is an illustration 400 that shows providing depth information along with lighting data of an object to a user in accordance with some embodiments described herein. Renders comprising 3D virtual objects as detailed provide surface reflectance information to the user 102. Embodiments are disclosed herein to additionally provide depth information of an object also to the user 102. This can be achieved by providing a real-world model 402 of an object and enhancing it with the reflectance data as detailed herein. In some embodiments, the model 402 can have a marker, for example, a QR code printed thereon. This enables associating or anchoring a volumetric display of the reflectance data of the corresponding object as generated by the wearable device 108 to the real-world model 402.

An image of the real-world model 402 is projected into the virtual environment with the corresponding volumetric rendering encompassing it. For example, FIG. 4 shows a display 406 of the model 402 as seen by the user 102 in the virtual space or environment. In this case, the virtual object 404 comprises a virtual outer surface of a real-world object such as a car. The virtual object 404 comprising the virtual outer surface encodes real-world surface (diffuse, specular, caustic, reflectance, etc.) properties of the car object and a size of the virtual object can be the same as or can be substantially different than the model 402. If the size of the virtual surface is the same as the model 402, the user 102 will see a display which is the same size as the model 402. If the size of the virtual object 404 is larger or smaller than the model 402, the display 406 will accordingly appear larger or smaller than the real-world object 402.

The surface details 404 of a corresponding real-world object are projected on to the real-world model 402 to generate the display 406. The display 406 can comprise a volumetric 3D display in some embodiments. As a result, the model 402 with its surface details 404 appears as a unitary whole to the user 102 handling the model 402. Alternately, the model 402 appears to the user 102 as having its surface details 404 painted thereon. Moreover, a manipulation of the real-world model 402 appears to cause changes to the unitary whole seen by the user 102 in the virtual environment.

In some embodiments, the QR code or the marker can be indicative of the user 102 purchase of a particular rendering. Hence, when the camera of the wearable device 108 scans the QR code, the appropriate rendering is retrieved by the wearable device 108 from the server (not shown) and projected on to the model 402. For example, a user that has purchased a rendering for a particular car model and color would see such rendering in the display 406 whereas a user who hasn't made a purchase of any specific rendering may see a generic rendering for a car in the display 406. In some embodiments, the marker may be used only for positioning the 3D display relative to the model 402 in the virtual space so that a single model can be used with different renderings. Such embodiments facilitate providing in-app purchases wherein the user 102 can elect to purchase or rent a rendering along with any audio/video/tactile data while in the virtual environment or via the computing device 206 as will be detailed further infra.

The model 402 as detailed above is the model of a car which exists in the real-world. In this case, both the geometric properties such as the size and shape and the optical properties such as the lighting and reflectance of the display 406 are similar to the car whose model is virtualized via the display 406. However, it may be appreciated that this is not necessary that a model can be generated in accordance with the above-described embodiments wherein the model corresponds to a virtual object that does not exist in the real-world. In some embodiments, one or more of the geometric properties such as the size and shape or the optical properties of the virtual object can be substantially different from the real-world object and/or the 3D printed model. For example, a 3D display can be generated wherein the real-world 3D model 402 may have a certain colored surface while the virtual surface projected thereon in the final 3D display may have a different color.

The real-world model 402 can be comprised of various metallic or non-metallic materials such as but not limited to paper, plastic, metal, wood, glass or combinations thereof In some embodiments, the marker on the real-world model 402 can be a removable or replaceable marker. In some embodiments, the marker can be a permanent marker. The marker can be without limitation, printed, etched, chiseled, glued or otherwise attached to or made integral with the real-world model 402. In some embodiments, the model 402 can be generated, for example, by a 3D printer. In some embodiments, the surface reflectance data of objects, such as those existing in the real-world for example, that is projected as a volumetric 3D display can be obtained by an apparatus such as the light stage. In some embodiments, the surface reflectance data of objects can be generated wholly by a computing apparatus. For example, object surface appearance can be modeled utilizing bi-directional reflectance distribution functions (“BRDFs”) which can be used in generating the 3D displays.

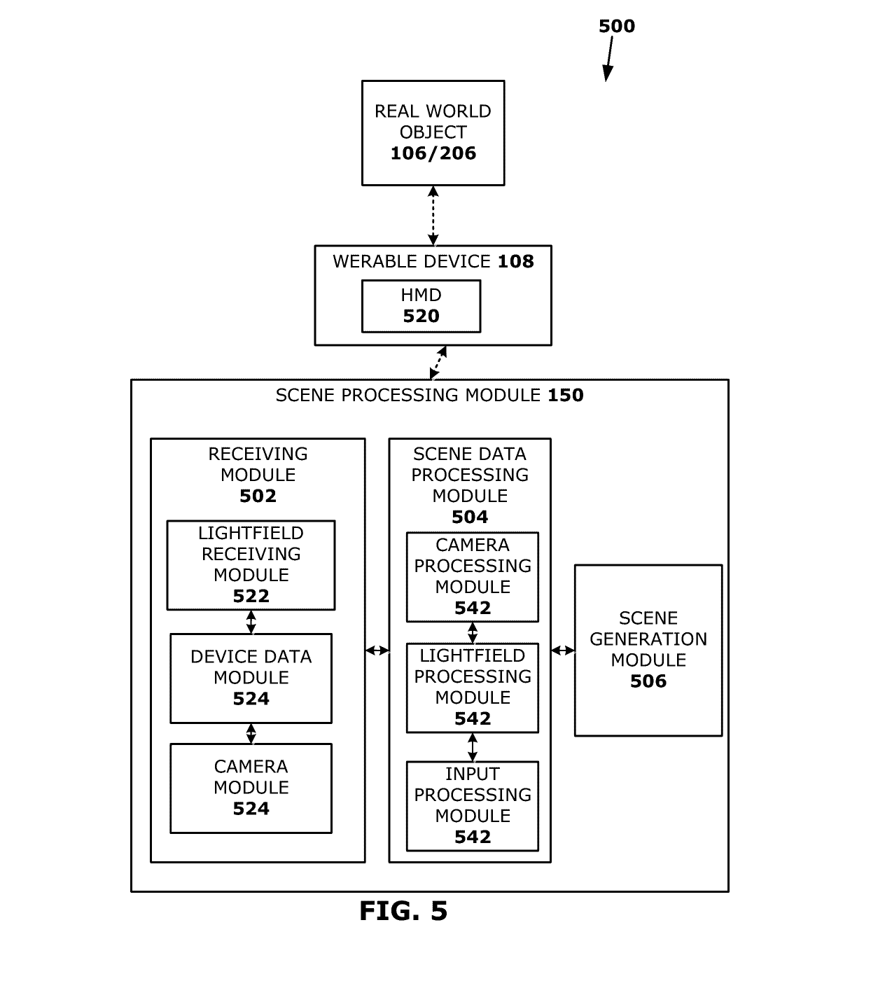

FIG. 5 is a schematic diagram 500 of a system for establishing a control mechanism for volumetric displays in accordance with embodiments described herein. The system 500 comprises the real-world object 106/206, the wearable device 108 comprising a head-mounted display (HMD) 520 and communicably coupled to a scene processing module 150. The HMD 520 can comprise the lenses comprised in the wearable device 108 which display the generated virtual objects to the user 102. In some embodiments, the scene processing module 150 can be comprised in the wearable device 108 so that the data related to generating an AR/VR scene is processed at the wearable device 108. In some embodiments, the scene processing module 150 can receive a rendered scene and employ the API (Application Programming Interface) of the wearable device 108 to generate the VR/AR scene on the HMD.

The scene processing module 150 comprises a receiving module 502, a scene data processing module 504 and a scene generation module 506. The receiving module 502 is configured to receive data from different sources. Hence, the receiving module 502 can include further sub-modules which comprise without limitation, a light field module 522, a device data module 524 and a camera module 526. The light field module 522 is configured to receive light field which can be further processed to generate a viewport for the user 102. In some embodiments, the light field data can be generated at a short-range networked source such as a gaming device or it can be received at the wearable device 108 from a distant source such as a remote server. In some embodiment, the light field data can also be retrieved from the local storage of the wearable device 108.

A device data module 524 is configured to receive data from various devices including the communicatively-coupled real-world object which is the computing device 206. In some embodiments, the device data module 524 is configured to receive data from the positioning/motion sensors such as the accelerometers, magnetometers, compass and/or the gyroscopes of one or more of the wearable device 108 and the computing device 206. This enables a precise relative positioning of the wearable device 108 and the computing device 206. The data can comprise processed user input data obtained by the touchscreen sensors of the real-world object 206. Such data can be processed to determine the contents of the AR/VR scene and/or the changes to be applied to a rendered AR/VR scene. In some embodiments, the device data module 524 can be further configured to receive data from devices such as the accelerometers, gyroscopes or other sensors that are onboard the wearable computing device 108.

The camera module 526 is configured to receive image data from one or more of a camera associated with the wearable device 108 and a camera associated with the real-world object 204. Such camera data, in addition to the data received by the device data module 524, can be processed to determine the positioning and orientation of the wearable device 108 relative to the real-world object 204. Based on the type of real-world object employed by the user 102, one or more of the sub-modules included in the receiving module 502 can be employed for collecting data. For example, if the real-world object 106 or a model 402 is used, sub-modules such as the device data module 524 may not be employed in the data collection process as no user input data is transmitted by such real-world objects.

The scene data processing module 504 comprises a camera processing module 542, a light field processing module 544 and input data processing module 546. The camera processing module 542 initially receives the data from a back-facing camera attached to the wearable device 108 to detect and/or determine the position of a real-world object relative to the wearable device 108. If the real-world object does not itself comprise a camera, then data from the wearable device camera is processed to determine the relative position and/or orientation of the real-world object. For the computing device 206 which can also include a camera, data from its camera can also be used to more accurately determine the relative positions of the wearable device 108 and the computing device 206. The data from the wearable device camera is also analyzed to identify a marker, its position and orientation relative to the real-world object 106 that comprises the marker thereon. As discussed supra, one or more virtual objects can be generated and/or manipulated relative to the marker. In addition, if the marker is being used to generate a purchased render on a model, then the render can be selected based on the marker as identified from the data of the wearable device camera. Moreover, processing of the camera data can also be used to trace the trajectory if one or more of the wearable device 108 and the real-world object 106 or 206 are in motion. Such data can be further processed to determine a AR/VR scene or changes that may be needed to existing virtual objects in a rendered scene. For example, the size of the virtual objects 104/204 may be increased or decreased based on the movement of the user's head 130 as analyzed by the camera processing module 542.

The light field processing module 544 processes the light field data obtained from one or more of the local, peer-to-peer or cloud-based networked sources to generate one or more virtual objects relative to an identified real-world object. The light field data can comprise without limitation, information regarding the render assets such as avatars within a virtual environment and state information of the render assets. Based on the received data, the light field module 544 outputs scene-appropriate 2D/3D geometry and textures, RGB data for the virtual object 104/204. In some embodiments, the state information of the virtual objects 104/204 (such as spatial position and orientation parameters) can also be a function of the position/orientation of the real-world objects 106/206 as determined by the camera processing module 542. In some embodiments wherein objects such as the real-world object 104 are used data from the camera processing module 542 and the light field processing module 544 can be combined to generate the virtual object 106 as no user touch-input data is generated.

In embodiments wherein the computing device is used as the real world object 206, the input processing module 546 is employed to further analyze data received from the computing device 206 and determine changes to rendered virtual objects. As described supra, the input data processing module 546 is configured to receive position and/or motion sensor data such as data from the accelerometers and/or the gyroscopes of the computing device 206 to accurately position the computing device 206 relative to the wearable device 108. Such data may be received via a communication channel established between the wearable device 108 and the computing device 206. By the way of illustration and not limitation, the sensor data can be received as packetized data via the short-range network from the computing device 206 wherein the packets are configured for example, in FourCC (four character code) format. In some embodiments, the scene processing module 150 can employ sensor data fusion techniques such as but not limited to Kalman filters or multiple view geometry to fuse image data in order to determine the relative position of the computing device 206 and the wearable device 108. Based on the positioning and/or motion of the computing device 206, changes may be effected in one or more of the visible and invisible attributes of the virtual object 204.

In addition, the input processing module 546 can be configured to receive pre-processed data regarding user gestures from the computing device 206. This enables interaction of the user 102 with the virtual object 204 wherein the user 102 executes particular gestures in order to effect desired changes in the various attributes of the virtual object 204. Various types of user gestures can be recognized and associated with a variety of attribute changes of the rendered virtual objects. Such correspondence between the user gestures and changes to be applied to the virtual objects can be determined by the programming logic associated with one or more of the virtual object 204 and the virtual environment in which it is generated. User gestures such as but not limited to tap, swipe, scroll, pinch, zoom executed on the touchscreen 212 and further tilting, moving, rotating or otherwise interacting with the computing device 206 can be analyzed by the input processing module 546 to determine a corresponding action.

In some embodiments, the visible attributes of the virtual objects 104/204 and the changes to be applied to such attributes can be determined by the input processing module 546 based on the pre-processed user input data. In some embodiments, invisible attributes of the virtual objects 104/204 can also be determined based on the data analysis of the input processing module 546.

The output from the various sub-modules of the scene data processing module 504 is received by the scene generation module 506 to generate a viewport that displays the virtual objects 104/204 to the user. The scene generation module 506 thus executes the final assembly and packaging of the scene based on all sources and then interacting with the HMD API to create final output. The final virtual or augmented reality scene is output to the HMD by the scene generation module 506.

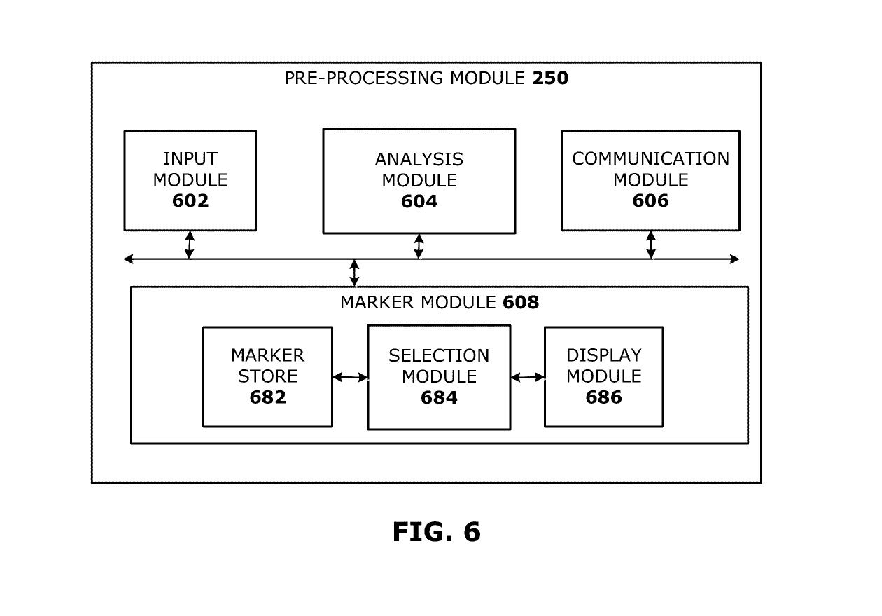

FIG. 6 is a schematic diagram of a preprocessing module 250 in accordance with some embodiments. The preprocessing module 250 comprised in the real-world object 206 receives input data from the various sensors of the computing device 206 and generates data that the scene processing module 150 can employ to manipulate one or more of the virtual objects 104/204 and the virtual environment. The preprocessing module 250 comprises an input module 602, an analysis module 604, a communication module 606 and a render module 608. The input module 602 is configured to receive input from the various sensors and components comprised in the real-world object 204 such as but not limited to its camera, position/motion sensors such as accelerometers, magnetometers or gyroscopes and touchscreen sensors. Transmission of such sensor data from the computing device 206 to the wearable device 108 provides a more cohesive user experience. This addresses one of the issues involving tracking of real-world objects and virtual objects which generally leads to a poor user experience. Facilitating a two-way communication between the sensors and cameras of the computing device 206 and the wearable device 108 and fusing sensor data from both the devices 108, 206 can result in significantly less error in tracking of the objects in the virtual and real-world 3D space and therefore lead to a better user experience.

The analysis module 604 processes data received by the input module 602 to determine the various tasks to be executed. Data from the camera of the computing device 206 and from the position/motion sensors such as the accelerometer and gyroscopes is processed to determine positioning data that comprises one or more of the position, orientation and trajectory of the computing device 206 relative to the wearable device 108. The positioning data is employed in conjunction with the data from the device data receiving module 524 and the camera module 526 to more accurately determine the positions of the computing device 206 and the wearable device 108 relative to each other. The analysis module 604 can be further configured to process raw sensor data, for example, from the touchscreen sensors to identify particular user gestures. These can include known user gestures or gestures that are unique to a virtual environment. In some embodiments, the user 102 can provide a multi-finger input for example, which input may correspond to a gesture associated with a particular virtual environment. In this case, the analysis module 604 can be configured to determine information such as the magnitude and direction of the user's touch vector and transmit the information to the scene processing module 150.

The processed sensor data from the analysis module 604 is transmitted to the communication module 606. The processed sensor data is packaged and compressed by the communication module 606. Furthermore the communication module 606 also comprises programming instructions to determine an optimal way of transmitting the packaged data to the wearable device 108. As mentioned herein, the computing device 206 can be connected to the wearable device 108 via different communication networks. Based on the quality or speed, a network can be selected by the communication module 606 for transmitting the packaged sensor data to the wearable device 108.

The marker module 608 is configured to generate a marker based on a user selection or based on predetermined information related to a virtual environment. The marker module 608 comprises a marker store 682, a selection module 684 and a display module 686. The marker store 682 can be a portion of the local storage medium included in the computing device 206. The marker store 682 comprises a plurality of markers corresponding to different virtual objects that can be rendered on the computing device 206. In some embodiments, when the user of the computing device 206 is authorized to permanently or temporarily access a rendering due to a purchase from an online or offline vendor, as a reward, or other reasons, a marker associated with the rendering can be downloaded and stored in the marker store 682. It may be appreciated that the marker store 682 may not include markers for all virtual objects that can be rendered as virtual objects. This is because, in some embodiments, virtual objects other than those pertaining to the plurality of markers may be rendered based, for example, on the information in a virtual environment. As the markers can comprise encoded data structures or images such as QR codes or bar-codes, they can be associated with natural language tags which can be displayed for user selection of particular renderings.

The selection module 684 is configured to select one or more of the markers from the marker store 682 for display. The selection module 684 is configured to select markers based on user input in some embodiments. The selection module 684 is also configured for automatic selection of markers based on input from the wearable device 108 regarding a particular virtual environment in some embodiments. Information regarding the selected marker is communicated to the display module 686 which displays one or more of the selected markers on the touchscreen 212. If the markers are selected by the user 102, then the position of the markers can either be provided by the user 102 or may be automatically based on a predetermined configuration. For example, if the user 102 selects markers to play a game, then the selected markers may be automatically arranged based on a predetermined configuration associated with the game. Similarly, if the markers are automatically selected based on a virtual environment, then they may be automatically arranged based on information regarding the virtual environment as received from the wearable computing device. The data regarding the selected marker is received by the display module 684 which retrieves the selected marker from the marker store 682 and displays it on the touchscreen 212.

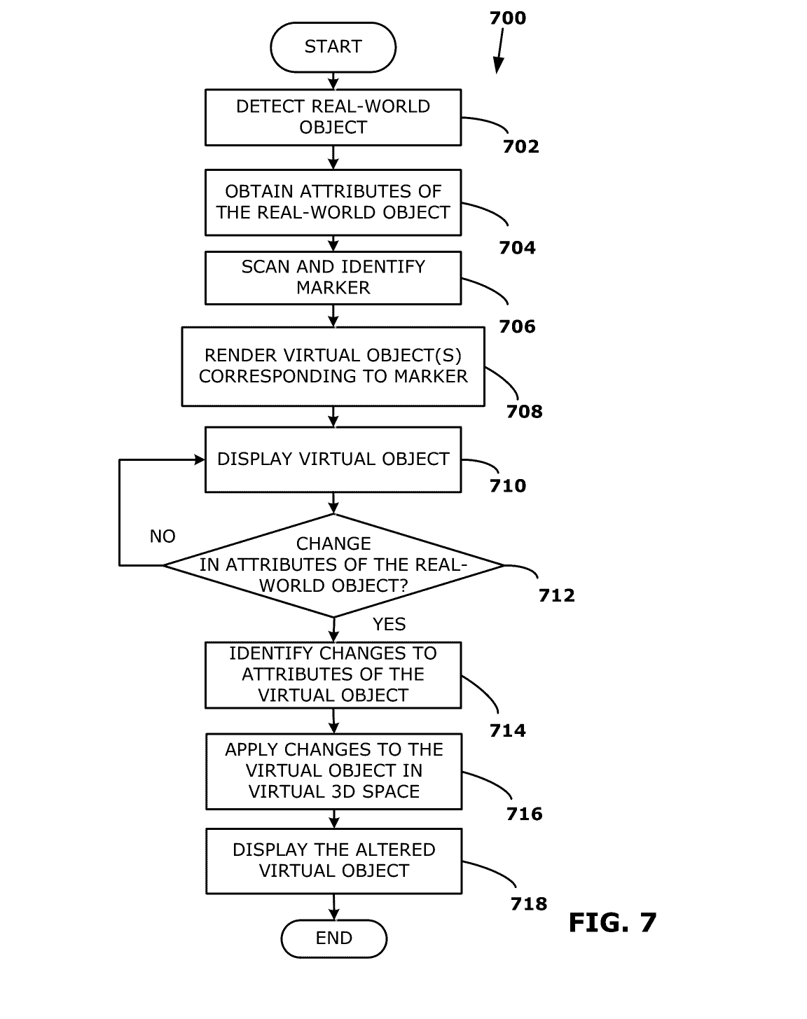

FIG. 7 is an exemplary flowchart 700 that details a method of enabling user interaction with virtual objects in accordance with one embodiment. The method begins at 702 wherein the presence of the real-world object 106/206 in the real 3D space having a marker 110/210 on its surface 112/212 is detected. The cameras included in the wearable device 108 enable the scene processing module 150 to detect the real-world object 106/206 in some embodiments. In embodiments wherein the real-world object is a computing device 206, information from its positioning/motion sensors such as but not limited to accelerometers, gyroscopes or compass can also be employed for determining its attributes which in turn enhances the precision of such determinations.

At 704, attributes of the marker 110/210 or the computing device 206 such as its position and orientation in the real 3D space relative to the wearable device 108 or relative to the user's 102 eyes wearing the wearable device 108 are obtained. In some embodiments, the attributes can be obtained by analyzing data from the cameras and accelerometers/gyroscopes included in the wearable device 108 and the real-world object 206. As mentioned supra, data from cameras and sensors can be exchanged between the wearable device 108 and the computing device 206 via a communication channel. Various analysis techniques such as but not limited to

Kalman filters can be employed to process the sensor data and provide outputs, which outputs can be used to program the virtual objects and/or virtual scenes. At 706, the marker 110/210 is scanned and any encoded information therein is determined.

At 708, one or more virtual object(s) 104/204 are rendered in the 3D virtual space. Their initial position and orientation can depend on the position/orientation of the real-world object 106/206 as seen by the user 102 from the display of the wearable device 108. The position of the virtual object 104/204 on the surface 112/212 of the computing device 206 will depend on the relative position of the marker 110/210 on the surface 112/212. Unlike the objects in the real 3D space such as the real-world object 104/204 or the marker 110/210 which are visible to users with naked eyes, the virtual object 104/204 rendered at 708 in virtual 3D space are visible only to the user 102 who wears the wearable device 108. The virtual object 104/204 rendered at 708 can also be visible to other users based on their respective view when they have on respective wearable devices which are configured to view the rendered objects. However, the view generated for other users may show the virtual object 104/204 from their own perspectives which would be based on their perspective view of the real-world object 106/206/marker 110/210 in the real 3D space. Hence, multiple viewers can simultaneously view and interact with the virtual object 204. The interaction of one of users with the virtual object 104/204 can be visible to other users based on their perspective view of the virtual object 104/204. Moreover, the virtual object 104/204 is also configured to be controlled or manipulable in the virtual 3D space via a manipulation of/interaction with the real-world object 106/206 in the real 3D space.

In some embodiments, a processor in communication with the wearable device 108 can render the virtual object 104/204 and transmit the rendering to the wearable device 108 for display to the user 102. The rendering processor can be communicatively coupled to the wearable device 108 either through a short-range communication network such as a Bluetooth network or through a long-range network such as the Wi-Fi network. The rendering processor can be comprised in a gaming device located at the user's 102 location and connected to the wearable device 108. The rendering processor can be comprised in a server located at a remote location from the user 102 and transmitting the rendering through networks such as the Internet. In some embodiments, the processor comprised in the wearable device 108 can generate the render the virtual object 204. At 710 the rendered virtual object 104/204 is displayed in the virtual 3D space to the user 102 on a display screen of the wearable device 108.

It is determined at 712 if a change in one of the attributes of the real-world object 106/206 has occurred. Detectable attributes changes of the real-world object 106/206 comprise but are not limited to, changes in the position, orientation, states of rest/motion and changes occurring on the touchscreen 212 such as the presence or movement of the user's 102 fingers if the computing device 206 is being used as the real-world object. In the latter case, the computing device 206 can be configured to transmit its attributes or any changes thereof to the wearable device 108. If no change is detected at 712, the process returns to 710 to continue display of the virtual object 104/204. If a change is detected at 712, data regarding the detected changes are analyzed and a corresponding change to be applied to the virtual object 104/204 is identified at 714. At 716, the change in one or more attributes of the virtual object 104/204 as identified at 714 is affected. The virtual object 104/204 with the altered attributes is displayed at 718 to the user 102 on the display of the wearable device 108.

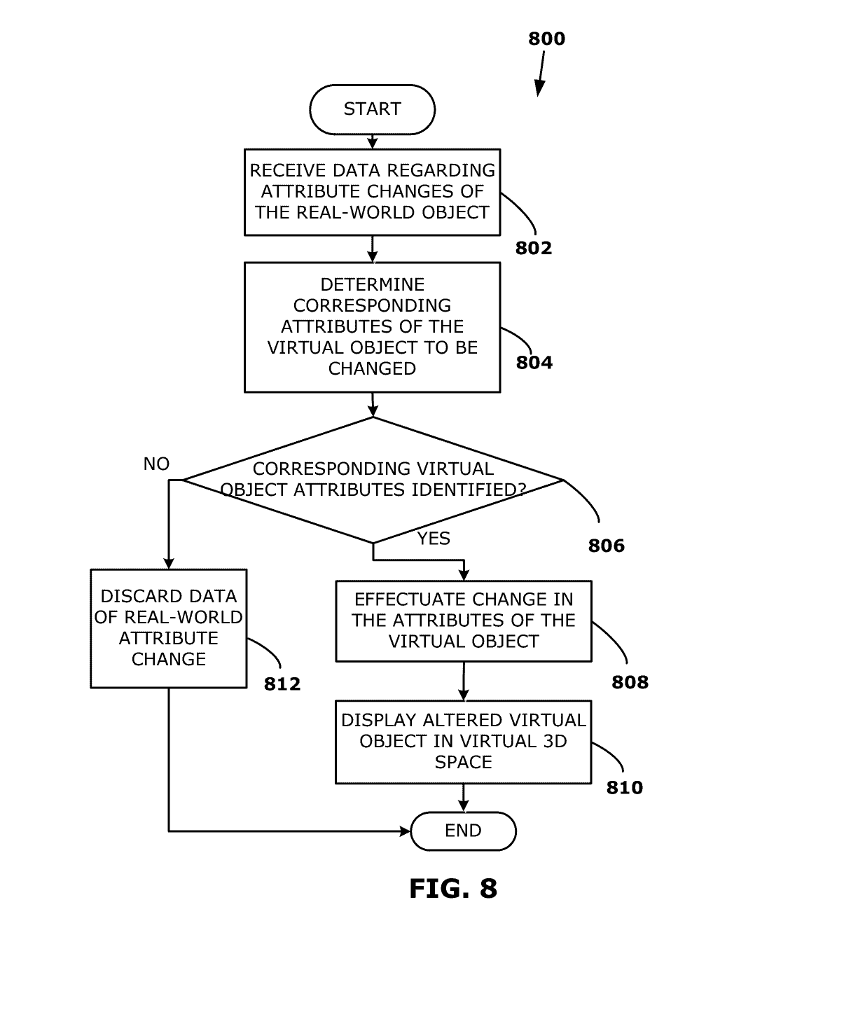

FIG. 8 is an exemplary flowchart 800 that details a method analyzing data regarding changes to the real-world object attributes and identifying corresponding changes to the virtual object 204 in accordance with some embodiments. The method begins at 802 wherein data regarding attribute changes to the real-world object 106/206 is received. At 804, the corresponding attribute changes to be made to the virtual object 104/204 are determined. Various changes to visible and invisible attributes of the virtual object 104/204 in the virtual 3D space can be effectuated via changes made to the attributes of the real-world object 104/204 in the real 3D space. Such changes can be coded or program logic can be included for the virtual object 104/204 and/or the virtual environment in which the virtual object 104204 is generated. Hence, the mapping of the changes in attributes of the real-world object 206 to the virtual object 104/204 is constrained upon the limits in the programming of the virtual object 104/204 and/or the virtual environment. If it is determined at 806 that one or more attributes of the virtual object 104/204 are to be changed, then the corresponding changes are effectuated to the virtual object 104/204 at 808. The altered virtual object 104/204 is displayed to the user at 810. If no virtual object attributes to be changed are determined at 806, the data regarding the changes to the real-world object attributes is discarded at 812 and the process terminates on the end block.

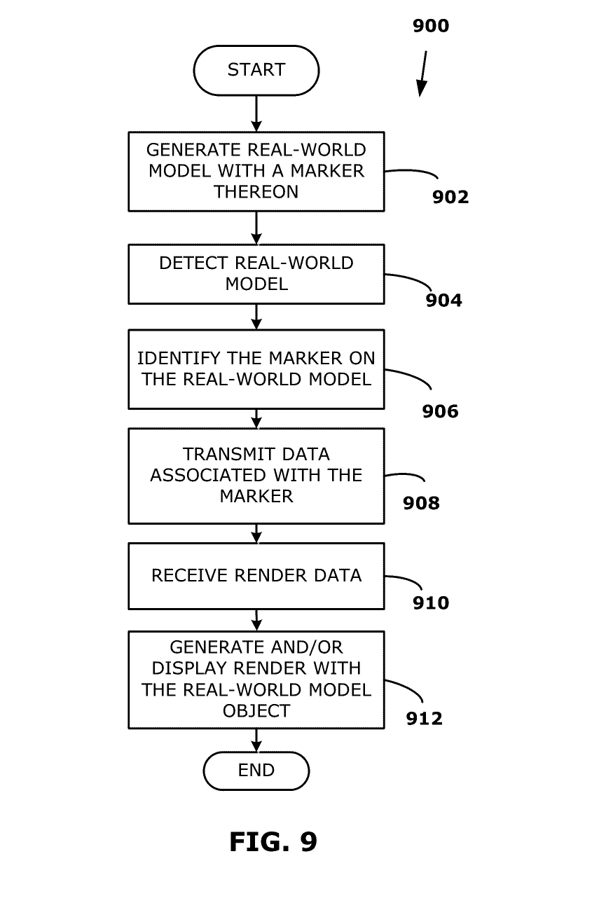

FIG. 9 is an exemplary method of providing lighting data of an object along with its depth information in accordance with some embodiments described herein. The method begins at 902 wherein a real-world model 402 with a marker attached or integral thereto is generated at 902. As described herein, the real-world model 402 can be generated from various materials via different methods. For example, it can be carved, chiseled, etched on various materials. In some embodiments, it can be a resin model obtained via a 3D printer. The user 102 may procure such real-world model, such as the model 402, for example, from a vendor. The presence of a real-world model 402 of an object existing in the real 3D space is detected at 904 when the user 102 holds the model 402 in the field of view of the wearable device 108. At 906, a marker on a surface of the real-world model is identified. In addition, the marker also aids in determining the attributes of the model 402 such as its position and orientation in the real 3D space. In some embodiments, the marker can be a QR code or a bar code with information regarding a rendering encoded therein. Accordingly, at 908 the data associated with the marker is transmitted to a remote server. At 910, data associated with a rendering for the model 402 is received from the remote server. The real-world model 402 in conjunction with the received rendering is displayed to the user 102 at 912. In some embodiments, a 3D image of the real-world model 402 may initially appear in the virtual space upon the detection of its presence at step 904 and the rendering subsequently appears on the 3D image at step 912.

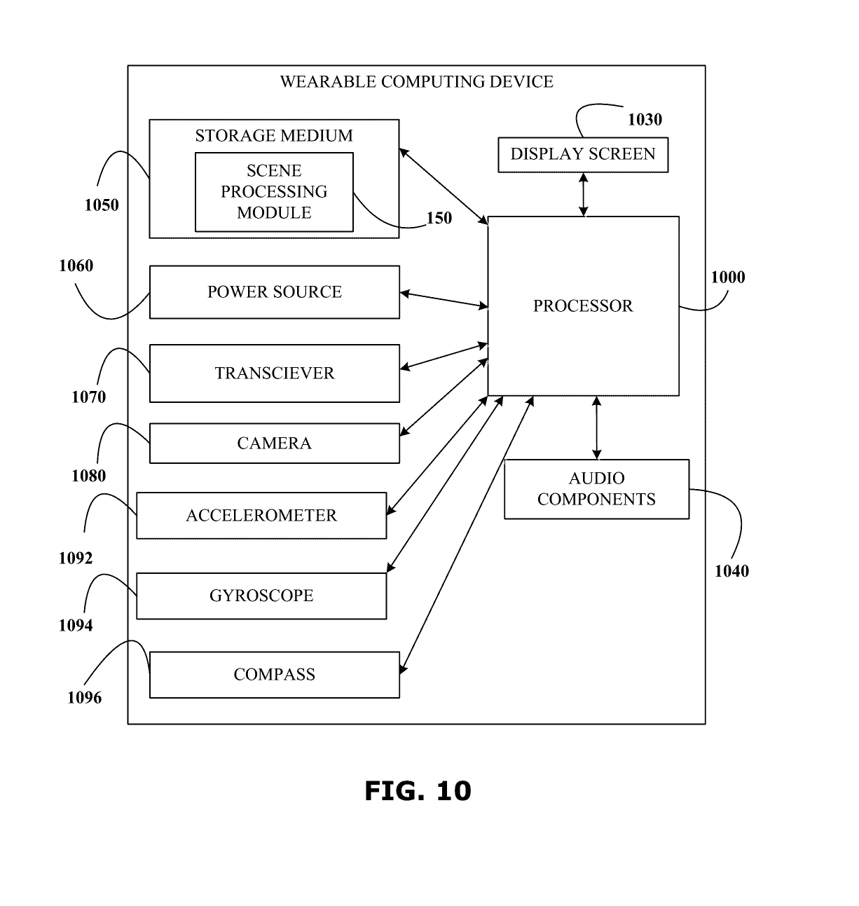

FIG. 10 is a block diagram depicting certain example modules within the wearable computing device in accordance with some embodiments. It can be appreciated that certain embodiments of the wearable computing system/device 100 can include more or less modules than those shown in FIG. 10. The wearable device 108 comprises a processor 1000, display screen 1030, audio components 1040, storage medium 1050, power source 1060, transceiver 1070 and a detection module/system 1080. It can be appreciated that although only one processor 1000 is shown, the wearable device 108 can include multiple processors or the processor 1000 can include task-specific sub-processors. For example the processor 1000 can include a general purpose sub-processor for controlling the various equipment comprised within the wearable device 108 and a dedicated graphics processor for generating and manipulating the displays on the display screen 1030.

The scene processing module 150 comprised in the storage medium 1050 and when activated by the user 102, is loaded by the processor 1000 for execution. The various modules comprising programming logic associated with the various tasks are executed by the processor 1000 and accordingly different components such as the display screen 1030 which can be the HMD 520, audio components 1040, transceiver 1070 or any tactile input/output elements can be activated based on inputs from such programming modules.

Different types of inputs from are received by the processor 1000 from the various components such as user gesture input from the real-world object 106, or audio inputs from audio components 1040 such as a microphone. The processor 1000 can also receive inputs related to the content to be displayed on the display screen 1030 from local storage medium 1050 or from a remote server (not shown) via the transceiver 1070. The processor 1000 is also configured or programmed with instructions to provide appropriate outputs to different modules of the wearable device 108 and other networked resources such as the remote server (not shown).

The various inputs thus received from different modules are processed by the appropriate programming or processing logic executed by the processor 1000 which provides responsive output as detailed herein. The programming logic can be stored in a memory unit that is on board the processor 1000 or the programming logic can be retrieved from the external processor readable storage device/medium 1050 and can be loaded by the processor 1000 as required. In an embodiment, the processor 1000 executes programming logic to display content streamed by the remote server on the display screen 1030. In this case the processor 1000 may merely display a received render. Such embodiments enable displaying high quality graphics on wearable devices even while mitigating the need to have powerful processors on board the wearable devices. In an embodiment, the processor 1000 can execute display manipulation logic in order to make changes to the displayed content based on the user input received from the real-world object 106. The display manipulation logic executed by the processor 1000 can be the programming logic associated with the virtual objects 104/204 or the virtual environment in which the virtual objects 104/204 are generated. The displays generated by the processor 1000 in accordance with embodiments herein can be AR displays where the renders are overlaid over real-world objects that the user 102 is able to see through the display screen 1030. The displays generated by the processor in accordance with embodiments herein can be VR displays where the user 102 is immersed in the virtual world and is unable to see the real-world. The wearable device 108 also comprises a camera 1080 which is capable of recording image data in its field of view as photographs or as audio/video data. In addition, it also comprises positioning/motion sensing elements such as an accelerometer 1092, gyroscope 1094 and compass 1096 which enable accurate position determination.

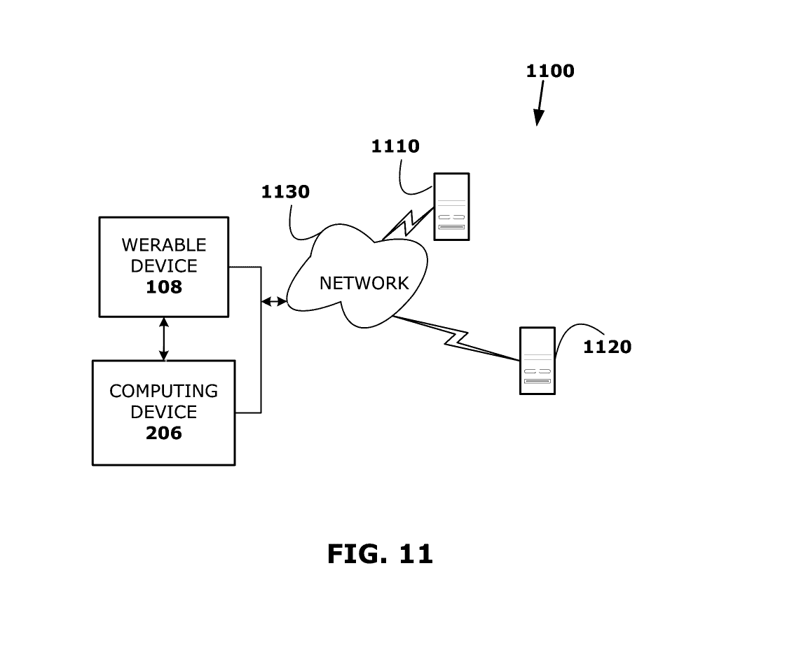

FIG. 11 is a schematic diagram that shows a system 1100 for purchase and downloading of renders in accordance with some embodiments. The system 1100 can comprises the wearable device 108, the real-world object which is the computing device 206, a vendor server 1110 and a storage server 1120 communicably coupled to each other via the network 1130 which can comprise the Internet. In some embodiments, the wearable device 108 and the computing device 206 may be coupled to each other via short-range networks as mentioned supra. Elements within the wearable device 108 and/or the computing device 206 which enable access to information/commercial sources such as websites can also enable the user 102 to make purchases of renders. In some embodiments, the user 102 can employ a browser comprised in the computing device 206 to visit the website of a vendor to purchases particular virtual objects. In some embodiments, virtual environments such as games, virtual book shops, entertainment applications and the like can include widgets that enable the wearable device 108 and/or the computing device 206 to contact the vendor server 1110 to make a purchase. Upon the user 102 completing the purchase transaction, the information such as the marker 110/210 associated with a purchased virtual object 104/204 is transmitted by the vendor server 1110 to a device specified by the user 102. When the user 102 employs the marker 110/210 to access the virtual object 104/204, the code associated with rendering of the virtual object 104/204 is retrieved from the storage server 1120 and transmitted to the wearable device 108 for rendering. In some embodiments, the code can be stored locally in a user-specified device such as but not limited to one of the wearable device 108 or the computing device 206 for future access.

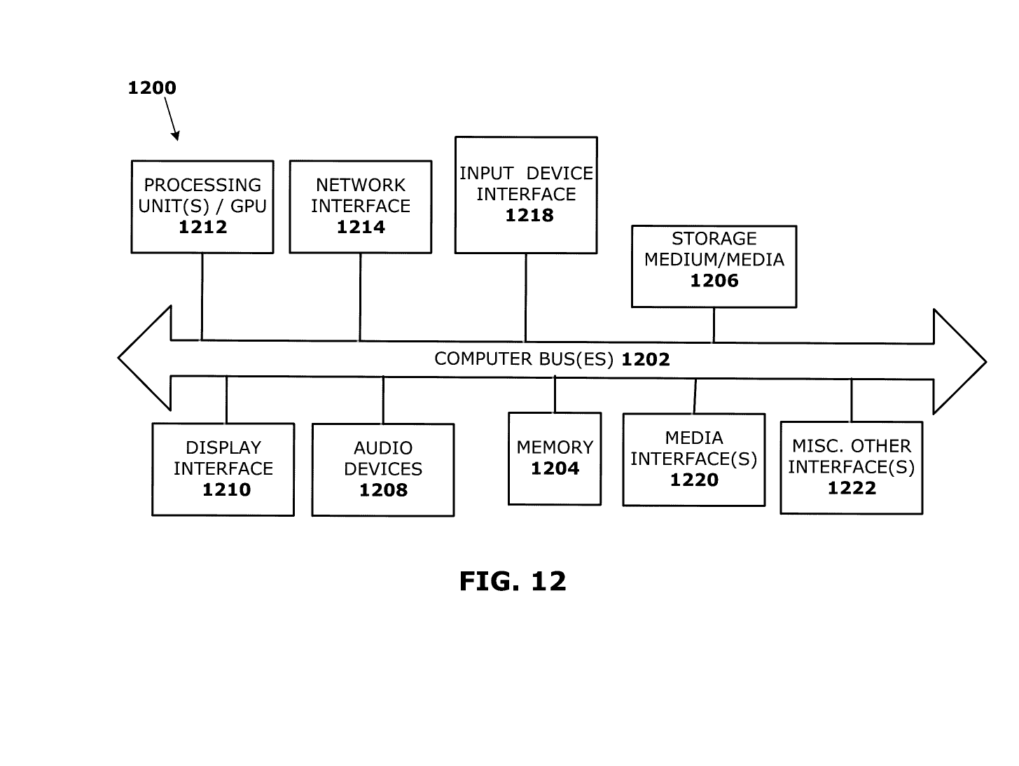

FIG. 12 is a schematic FIG. 1200 that shows internal architecture of a computing device 1200 which can be employed a remote server or a local gaming device transmitting renderings to the wearable device 108 in accordance with embodiments described herein. The computing device 1200 includes one or more processing units (also referred to herein as CPUs) 1212, which interface with at least one computer bus 1202. Also interfacing with computer bus 1202 are persistent storage medium/media 1206, network interface 1214, memory 1204, e.g., random access memory (RAM), run-time transient memory, read only memory (ROM), etc., media disk drive interface 1220 which is an interface for a drive that can read and/or write to media including removable media such as floppy, CD-ROM, DVD, etc., media, display interface 1210 as interface for a monitor or other display device, input device interface 1218 which can include one or more of an interface for a keyboard or a pointing device such as but not limited to a mouse, and miscellaneous other interfaces 1222 not shown individually, such as parallel and serial port interfaces, a universal serial bus (USB) interface, and the like.

Memory 1204 interfaces with computer bus 1202 so as to provide information stored in memory 1204 to CPU 1212 during execution of software programs such as an operating system, application programs, device drivers, and software modules that comprise program code or logic, and/or instructions for computer-executable process steps, incorporating functionality described herein, e.g., one or more of process flows described herein. CPU 1212 first loads instructions for the computer-executable process steps or logic from storage, e.g., memory 1204, storage medium/media 1206, removable media drive, and/or other storage device. CPU 1212 can then execute the stored process steps in order to execute the loaded computer-executable process steps. Stored data, e.g., data stored by a storage device, can be accessed by CPU 1212 during the execution of computer-executable process steps.

Persistent storage medium/media 1206 are computer readable storage medium(s) that can be used to store software and data, e.g., an operating system and one or more application programs. Persistent storage medium/media 1206 can also be used to store device drivers, such as one or more of a digital camera driver, monitor driver, printer driver, scanner driver, or other device drivers, web pages, content files, metadata, playlists and other files. Persistent storage medium/media 1206 can further include program modules/program logic in accordance with embodiments described herein and data files used to implement one or more embodiments of the present disclosure.

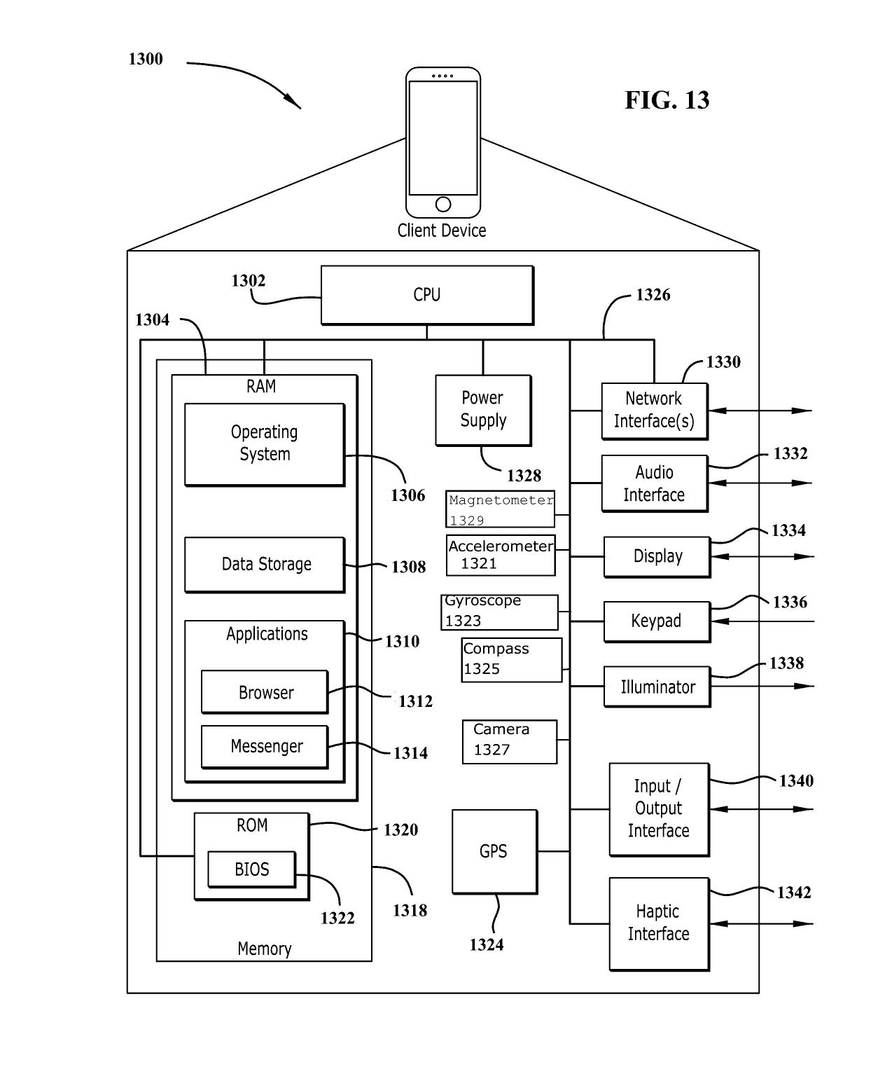

FIG. 13 is a schematic diagram illustrating a client device implementation of a computing device which can be used as, for example, the real-world object 206 in accordance with embodiments of the present disclosure. A client device 1300 may include a computing device capable of sending or receiving signals, such as via a wired or a wireless network, and capable of running application software or “apps” 1310. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 1302, power supply 1328, a memory 1318, ROM 1320, BIOS 1322, network interface(s) 1330, audio interface 1332, display 1334, keypad 1336, illuminator 1338, I/O interface 1340 interconnected via circuitry 1326. Claimed subject matter is intended to cover a wide range of potential variations. For example, the keypad 1336 of a cell phone may include a numeric keypad or a display 1334 of limited functionality, such as a monochrome liquid crystal display (LCD) for displaying text. In contrast, however, as another example, a web-enabled client device 1300 may include one or more physical or virtual keyboards 1336, mass storage, one or more accelerometers 1321, one or more gyroscopes 1323 and a compass 1325, magnetometer 1329, global positioning system (GPS) 1324 or other location identifying type capability, Haptic interface 1342, or a display with a high degree of functionality, such as a touch-sensitive color 2D or 3D display, for example. The memory 1318 can include Random Access Memory 1304 including an area for data storage 1308. The client device 1300 can also include a camera 1327 which is configured to obtain image data of objects in its field of view and record them as still photographs or as video.

A client device 1300 may include or may execute a variety of operating systems 1306, including a personal computer operating system, such as a Windows, iOS or Linux, or a mobile operating system, such as i0S, Android, or Windows Mobile, or the like. A client device 1300 may include or may execute a variety of possible applications 1310, such as a client software application 1314 enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A client device 1300 may also include or execute an application to communicate content, such as, for example, textual content, multimedia content, or the like. A client device 1300 may also include or execute an application to perform a variety of possible tasks, such as browsing 1312, searching, playing various forms of content, including locally stored or streamed content, such as, video, or games (such as fantasy sports leagues). The foregoing is provided to illustrate that claimed subject matter is intended to include a wide range of possible features or capabilities.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), program logic, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1) A method comprising:
detecting, by a processor in communication with a first display device, presence of a real-world object comprising a marker on a surface thereof;
identifying, by the processor, position and orientation of the real-world object in real 3D space relative to a user's eyes;
rendering, by the processor, a virtual object positioned and oriented in a virtual 3D space relative to the marker, and the virtual object configured for control in the virtual 3D space via manipulations of the real-world object in the real 3D space; and
transmitting render data, by the processor to the first display device, to visually present the virtual object in the virtual 3D space.

2) The method of claim 1, wherein the virtual object configured for control via manipulations of the real-world object further comprises:
detecting, by the processor, a change in one of the position and orientation of the real-world object.

3) The method of claim 2, further comprising:
altering, by the processor, one or more of a position and an orientation of the virtual object in the virtual space based on the detected change in the real-world object; and
transmitting, by the processor to the first display device, render data to visually display the virtual object at one or more of the altered positions and orientations based on the detected change.

4) The method of claim 1, the real world object is a second display device comprising a touchscreen, the first display device is communicatively coupled to a second display device, the coupling enabling exchange of data between the first display device and the second display device.

5) The method of claim 4, wherein the marker is detected on the touchscreen of the second display device.

6) The method of claim 4, further comprising:
receiving, by the processor, data regarding the user's touch input from the second display device; and
manipulating, by the processor, the virtual object or a virtual scene in the virtual space in response to the data regarding the user's touch input.

7) The method of claim 6, the data regarding the user's touch input comprising position information of the user's body part on the touchscreen relative to the marker.

8) The method of claim 7, the manipulation of the virtual object further comprising:
changing, by the processor, a position of the virtual object in the virtual space to track the position information.

9) The method of claim 6, the manipulation of the virtual object further comprising:
changing, by the processor, one or more of a size, shape, lighting and rendering properties of the virtual object in response to the user's touch input.

10) The method of claim 9, wherein the user's touch input corresponds to a gesture selected from a group of gestures consisting of a single or multi-tap, tap-and-hold, rotate, swipe, or pinch-zoom gesture.

11) The method of claim 4, further comprising:
receiving, by the processor, data regarding input from at least one of a plurality of sensors comprised in the second device;
manipulating, by the processor, the virtual object or a virtual scene in response to the sensor input data from the second device.

12) The method of claim 1, wherein the detecting of real world object comprises detection of a 3D printed model of another object.

13) The method of claim 12, wherein the virtual object comprises a virtual outer surface of the other object, the virtual outer surface encodes optical properties of a real-world surface material of the other object.

14) The method of claim 13, wherein one or more of geometric and rendering properties of the virtual object are substantially similar to corresponding properties of the 3D printed model.

15) The method of claim 14, further comprising:
receiving, by the processor, user input for purchase of render data of the virtual object; and
transmitting, by the processor, to a vendor server information regarding the user's purchase of the render data.

16) The method of claim 12, wherein one or more of other geometric or rendering properties of the virtual object are different from corresponding properties of the 3D printed model.

17) The method of claim 16, further comprising:
receiving, by the processor, user input for purchase of render data of the virtual object; and
transmitting, by the processor to a vendor server, information regarding the user's purchase of the render data.

18) The method of claim 16, further comprising:
detecting, by the processor, that the user has purchased render data of the virtual object for use with the 3D printed model;
rendering, by the processor, the virtual object in accordance with the purchased render data.

19) The method of claim 1, further comprising:
displaying, by the processor, the virtual object on a display of the first display device.

20) An apparatus comprising:
a processor;
a non-transitory storage medium having stored thereon processor-executable programming logic, the programming logic comprises:
presence detecting logic that detects in communication with a first display device, presence of a real-world object comprising a marker on a surface thereof;
identifying logic that identifies position and orientation of the real-world object in real 3D space relative to a user's eyes;
rendering logic that renders a virtual object positioned and oriented in a virtual 3D space relative to the marker;
manipulation logic that manipulates the virtual object responsive to a manipulation of the real-world object in the real 3D space; and
transmitting logic that transmits render data by the processor to visually display, the virtual object on in the virtual 3D space.

21) The apparatus of claim 20 the manipulation logic further comprises:
identifying logic that detects a change in the position or orientation of the real-world object.

22) The apparatus of claim 21, the manipulation logic further comprising:
altering logic that alters one or more attributes of the virtual object in the virtual space based on the detected change in the real-world object; and
displaying logic that displays to the user, the virtual object with the altered attributes.

23) The apparatus of claim 20, the first display device is communicatively coupled to a second display device, the coupling enabling exchange of data generated by the second display device.

24) The apparatus of claim 23, the marker is displayed on the touchscreen of the second display device.

25) The apparatus of claim 24, the manipulation logic further comprising:
receiving logic that receives data regarding the user's touch input from the second display device; and
logic for manipulating the virtual object in the virtual space in response to the data regarding the user's touch input.

26) The apparatus of claim 25, the data regarding the user's touch input comprising position information of the user's body part on the touchscreen relative to the marker.

27) The apparatus of claim 26, the manipulation logic further comprising:
altering logic that changes at least one of a position, orientation, size, and rendering properties of the virtual object in the virtual space

28) The apparatus of claim 26, the manipulation logic further comprising:
altering logic that changes at least one of a position, orientation, size, geometric and rendering properties of the virtual object in response to the user's touch input.

29) The apparatus of claim 20, the real world object is a 3D printed model of another object.

30) The apparatus of claim 29, the virtual object comprises a virtual outer surface of the other object, the virtual outer surface encodes real-world surface properties of the other object.

31) The apparatus of claim 30, the properties of the virtual object are substantially similar to the properties of the 3D printed model.

32) The apparatus of claim 30, a size of the virtual object is different from a size of the 3D printed model.

33) The apparatus of claim 20, the processor is comprised in the first display device.

34) The apparatus of claim 33, further comprising:
display logic that displays the virtual object on a display of the first display device.

35) A non-transitory processor-readable storage medium comprising processor-executable instructions for:
detecting, by the processor in communication with a first display device, presence of a real-world object comprising a marker on a surface thereof;
identifying, by the processor, position and orientation of the real-world object in real 3D space relative to a user's eyes;
rendering, by the processor, a virtual object positioned and oriented in a virtual 3D space relative to the marker, the virtual object configured for control via a manipulations of the real-world object in the real 3D space; and
transmitting render data, by the processor, to visually display, the virtual object in the virtual 3D space.

36) The non-transitory medium of claim 35, instructions for manipulation of the virtual object via manipulation of the real-world object further comprises instructions for:
detecting, by the processor, a change in one of the position and orientation of the real-world object.

37) The non-transitory medium of claim 35, the further comprising instructions for:
altering, by the processor, one or more attributes of the virtual object in the virtual space based on the detected change in the real-world object; and
displaying, by the processor to the user, the virtual object with the altered attributes.

38) The non-transitory medium of claim 35 the first display device is communicatively coupled to a second display device, the coupling enabling exchange of data generated by the second display device.

39) The non-transitory medium of claim 38, the marker is displayed on the touchscreen of the second display device.

40) The non-transitory medium of claim 39, further comprising instructions for:
receiving, by the processor, data regarding the user's touch input from the second display device; and
manipulating, by the processor, the virtual object in the virtual space in response to the data regarding the user's touch input.

41) The non-transitory medium of claim 35, the real world object is a 3D printed model of another object, the virtual object comprises a virtual outer surface of the other object, the virtual outer surface encodes real-world surface reflectance properties of the other object, and a size of the virtual object is substantially similar to a size of the 3D printed model.

42) The non-transitory medium of claim 41, further comprising instructions for:
rendering, by the processor, the virtual outer surface in response to further input indicating a purchase of the rendering.

43) The non-transitory medium of claim 35, the render data for the visual display data comprising display data for an image of the real-world object.

44) The non-transitory medium of claim 43, the render data comprises data that causes the virtual object to modify the image of the real-world object in the virtual 3D space
